(19) United States
(12) Patent Application Publication
(10) Pub. No.: US 2013/0304584 A1
(43) Pub. Date: Nov. 14, 2013

(54) METHOD AND APPARATUS FOR PROVIDING DATA TO A USER DEVICE

(71) Applicants: Charles McCoy, Coronado, CA (US); True Xiong, San Diego, CA (US); Ling Jun Wong, Champaign, IL (US)

(72) Inventors: Charles McCoy, Coronado, CA (US); True Xiong, San Diego, CA (US); Ling Jun Wong, Champaign, IL (US)

(73) Assignees: Sony Corporation, Tokyo (JP); Sony Network Entertainment International LLC, Los Angeles, CA (US)

(21) Appl. No.: 13/469,884

(22) Filed: May 11, 2012

(51) Int. Cl. G06Q 30/02; A63F 9/24

(52) U.S. Cl. 705/14.66; 463/42; 705/14.49

(57) ABSTRACT

An apparatus and method for providing data to a user device. The method includes accessing at least one game application for providing game content to the user device. A management application is used to communicate with the game application to control operation of the game application. Execution of the management application provides game content assets to selected user device based on parameters of the management application.

### BACKGROUND

1. Field of the Invention

This invention relates generally to a system and method of providing data to a user device. More specifically, it relates to providing gaming content and advertising data to a user.

2. Background Discussion

Typically, gaming content, such as video games and gaming accessories are utilized by devices to display game content. However, it is desirable to have a system that provides an enhanced gaming experience.

### SUMMARY

Embodiments of the present invention are directed to an enhanced gaming experience using a dedicated application for interacting with game content assets and user devices.

One embodiment of the present invention is directed to a method for providing data to a user device. The method includes accessing at least one game application for providing one or more associated game content assets to the user device and accessing at least one management application. The management application communicates with the game application to control execution of the game application. Advertisement content is accessed. Game content assets and selected advertisement content are provided to the selected user device based on the executed management application.

Another embodiment of the present invention is directed to a method for providing content to a user device that includes accessing one or more game content assets by the user device; accessing at least one management application, the management application controlling execution of the game content assets; identifying one or more processing modules that are available for use by the management application; providing one or more game content assets to the selected user device based on execution of the management application; and utilizing one or more of the identified processing modules based on execution of the management application to perform processing functionality.

Other embodiments of the present invention include the methods described above but implemented using apparatus or programmed as computer code to be executed by one or more processors operating in conjunction with one or more electronic storage media.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates an example of a network that supports embodiments of the present invention.

FIG. 2 shows an example of a display device that may be used according to an embodiment of the present invention.

FIG. 3 shows an example of a server module according to another embodiment of the present invention.

FIG. 4 illustrates a series of steps that can be used to provide game content to a user according to yet another embodiment of the present invention.

FIG. 5 illustrates a series of steps that can be used to provide device capability information according to yet another embodiment of the present invention.

FIG. 6 illustrates a series of steps that can be used to provide advertising content according to yet another embodiment of the present invention.

FIG. 7 illustrates a series of steps that can be used to identify additional processing devices according to yet another embodiment of the present invention.

FIG. 8 illustrates a flow of instructions and content between various modules according to yet another embodiment of the present invention.

FIG. 9 illustrates a flow of instructions and content between various modules according to yet another embodiment of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with each other and/or one or more electronic storage media.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices or modules.

Indeed, the present invention may be implemented in a distributed or “cloud” computing environment in which shared resources, software and information are provided to computers and other devices over a network, which may be, for example, the Internet. “Cloud computing” typically involves delivering hosted services over the Internet. A cloud service typically has three distinct characteristics that differentiate it from traditional hosting. One characteristic is that it is sold on demand, typically by the minute or the hour; secondly, it is elastic—a user can have as much or as little of a service as they want at any given time; and thirdly, the service is usually fully managed by the provider (the consumer needs nothing but a personal computer and Internet access). Significant innovations in virtualization and distributed computing, as well as improved access to high-speed Internet have accelerated interest in cloud computing. The cloud can be private or public. A public cloud typically sells services to anyone on the Internet. (Currently, Amazon Web Services™ is the largest public cloud provider.) A private cloud is a proprietary network or a data center that supplies hosted services to a limited number of people. When a service provider uses public cloud resources to create their private cloud, the result is called a virtual private cloud. Private or public, the goal of cloud computing is to provide easy, scalable access to computing.

“Distributed computing”, or “distributed systems” relate to a system of multiple autonomous computers or processing devices or facilities that communicate through a network. The computers interact with each other in order to achieve a particular goal. A computer program that runs in a distributed system is typically referred to as a “distributed program” and “distributed programming” is the process of writing such programs. Distributed computing also refers to the use of distributed systems to solve computational problems. Typically, in distributed computing, a problem is divided into multiple tasks, each of which is solved by one or more computers. In general, distributed computing is any computing that involves multiple computers remote from each other that each has a role in a computation problem or information processing.

While embodiments of the present invention are typically described in terms of a video game, embodiments of the present invention also include application embodiments and other program embodiments as well, such as widgets or other scripted programs. Furthermore, the term “web app” includes components including HTML (HyperText Mark-up Language), CSS (Cascading Style Sheets), ECMAScript where ECMAScript includes, for example, JavaScript, Jscript and Action Script, as well as Media file, which include image, video and audio files. The “web-app” may also contain content for use by browser plug-ins, such as ADOBE FLASH™ Additionally, various versions of each component can be used while typically the latest version supported by all clients will usually be used. While the latest version of HTML is HTML5, it is envisioned that later versions of HTML will also be used. Furthermore, various portions or components may be contained within other components or modules, such as having CSS information in-line directly in the HTML. Also, a “web-app” may execute without network communication or it may communicate with one or more servers. Other suitable languages may be used to write the web-app such that the management application as well as the game application may be web-apps.

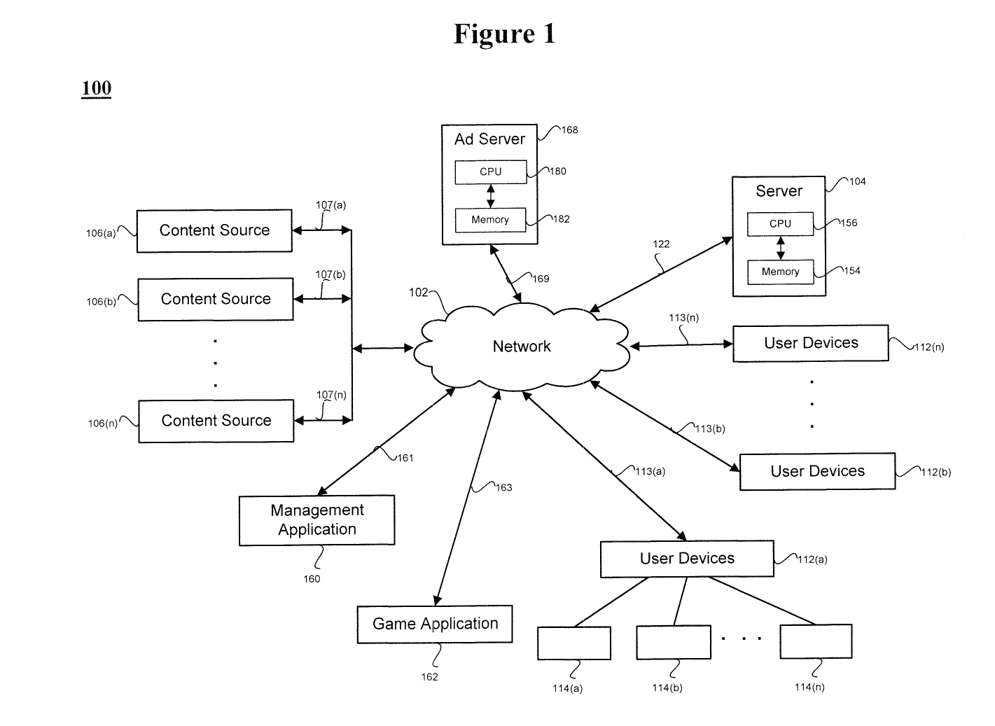

FIG. 1 shows a network environment 100 that supports embodiments of the present invention. As shown in FIG. 1, the system includes a communication network 102, a server 104, one or more content sources 106(a), 106(b) . . . 106(n) (where “n” is any suitable number), a plurality of user devices 112(a), 112(b) . . . 112(n) (where “n” is any suitable number), a management application module 160, a game application module 162 and an advertisement server module 168. The user devices (generally 112) may also have associated devices 114(a), 114(b) . . . 114(n) (where “n” is any suitable number) that may be used in conjunction with the user device 112. The management application module 160 may be a server, referred to as a management application server, herein. The game application module 162 may be a server, referred to as a game application server, herein.

The network 102 is, for example, any combination of linked computers, or processing devices, adapted to transfer and process data. The network 102 may be private Internet Protocol (IP) networks, as well as public IP networks, such as the Internet that can utilize World Wide Web (www) browsing functionality. An example of a wired network is a network that uses communication buses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

The server module, or facility, or unit, 104 is typically a server, computer, or other processing device(s) such as a desktop computer, laptop computer, and the like. While one server 104 is shown, any number of server modules could be used to perform the functionality of server 104. The server module 104 includes one or more memory modules 154 and one or more processors 156 and is bi-directionally coupled with network 102 via wired or wireless medium 122, which are typically bi-directional communication media, which may be for example a serial bus such as IEEE 1394, or other wire or wireless transmission mechanisms to transit audio data, video data, pixel data, streaming data, flat files, or any combination thereof, or any suitable electronic data between network 102 and server 104. The memory module 154 of the server 104 may comprise a plurality of algorithm storage modules that store the algorithms or applications, such as management application and/or game application as described herein.

It is noted that the server 104 may be a single server, and also may be implemented as one or more separate servers, which may be used in a cloud computing or distributed computing environment. The server module 104, which has associated processing capacity and storage capacity, is used to control flow of content from content source modules (generally 106) to user devices (generally 112), and may include advertising data from advertising server module 168 and/or applications from management application module 160 and/or game application module 162.

Content source modules 106(a), 106(b) . . . 106(n) are typically electronic storage media that store electronic content, such as game content assets, that may be provided to user devices 112. The game content assets may include video game data and the associated graphic data and sound data. The content source modules 106 may be for example repositories of gaming content, such as electronic games, game accessories, audio data, video data, IMDB (Internet Movie Data Base), streaming video storage locations or other suitable locations that store video data, audio data, pixel data or other electronic content that a user may wish to access (view and/or listen) using devices 112. Content source modules 106(a), 106(b) . . . 106(n) are in bi-directional communication with network 102 via associated communication medium 107(a), 107(b) . . . 107(n). The communication media (generally 107) are typically bi-directional communication media, which may be for example a serial bus such as IEEE 1394, or other wire or wireless transmission mechanisms to transit game content assets and other data (e.g., audio data, video data, pixel data, streaming data, flat files, or any combination thereof, or any suitable electronic data) between network 102 and content source modules 106.

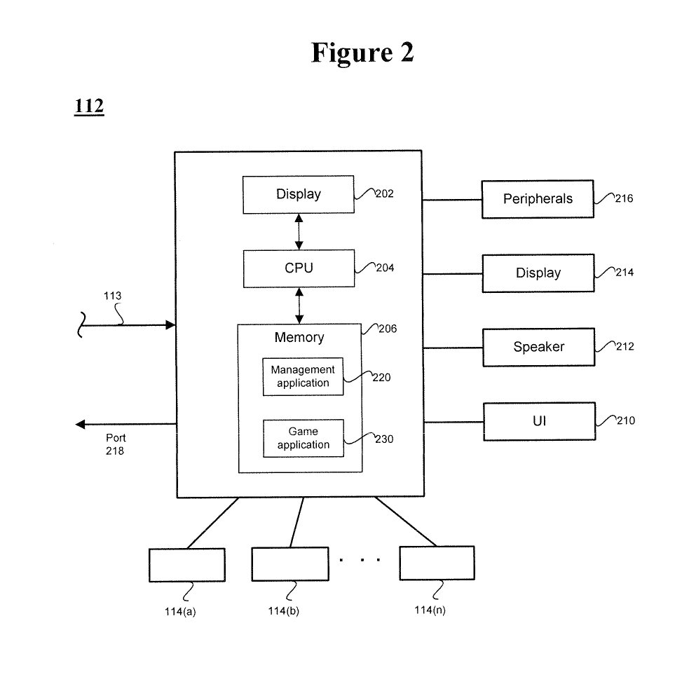

User devices 112(a), 112(b) . . . 112(n) (where “n” is any suitable number) are typically consumer electronic devices such as a television, IPTV television, HDTV, computer, such as a VAIO PC™, VAIO™ laptop, Mylo™, BLU-RAY™, PS3™ smart phone or other apparatus with sufficient processing and storage capability, or any device with a web browser to display and/or store electronic content, including game content assets. The user devices 112(a), 112(b) . . . 112(n) are typically connected to the communication network 102, via associated communication medium 113(a), 113(b) . . . 113(n). The communication media (generally 113) are typically bi-directional communication media, which may be for example a serial bus such as IEEE 1394, or other wire or wireless transmission mechanisms to transit audio data, video data, pixel data, streaming data, flat files, or any combination thereof, or any suitable electronic data between network 102 and user device 112. User device 112 may be any suitable consumer electronic (CE) unit or module or device. As shown in FIG. 2, the user devices 112 may be computer products.

A second device 114(a), 114(b) . . . 114(n) (where “n” is any suitable number) (generally referred to as 114 herein) may be associated with the user device 112 and may act as a visual and/or processing aid to the user device 112, particularly when the user device 112 is an IPTV device. The second device(s) 114 typically include devices such as a cellphone, laptop, etc., which execute program code thereby allowing the second device 114 to act as the visual and/or processing aid to the user device 112. A first one of the devices 114(a) (described as second device 114) may be associated with a first user and another one of those devices 114(b) may be associated with a second user. These devices 114(a) and 114(b) may be dedicated devices or independent devices, such as a smart phone, tablet computer, PDA (personal digital assistant), or other suitable device with adequate memory and processing power. The two devices 114(a) and 114(b) can be used by individual users who can both see device 112(a), which may be a display module, LCD, plasma or other suitable display device. Thus, the two users can play a game by using the devices 114(a) and 114(b) as controller devices and display the game on display device 112(a). Alternatively, a user using a second device (not shown) that is associated with another user device, i.e., 112(b) can also control a game being displayed on display device 112(a). As stated previously, in either embodiment, the controlling device (e.g., 114) may be a dedicated device, such as a game controller that communicates via a wire or wireless connection, such as Bluetooth. Alternatively, the controlling device (e.g., 114) may be an independent device, such as a smart phone or tablet computer that communicates via a network connection. Regardless of the type of device (dedicated or independent) the device (e.g., 114) may have one or more displays built into it. Furthermore, in the case of two users using separate control devices (114) to control a common game asset, each user has a “personal” screen on their device. The UI on the personal screen can display advertisement content directed to the particular user who is using the associated device. As will be discussed further herein, the advertisement content may be “actionable”, that is a user can activate the advertisement content so as to receive additional information. This “actionable” feature may depend on device capabilities, such as allowing the user to “click” on the displayed advertisement with a pointer or a touch screen to trigger an action, such as a request for more information. This action of activating advertisement data does not impair or affect the use of the device (114) to operate the game content asset. For example, a request for more information may send an email or message to the account of the user of that device for the user to view later. The advertisement content may also act to control the game, such as clicking on an ad for a particular brand would cause the user's character in the game to use items with that particular brand, such as clothing with a brand logo, or switching the vehicle to a model of car advertised. Content of various brands can have advantages over the default game content, in which case the advertisements can provide in-game advantages to the user and may be welcomed by the user as part of their game controls instead of being seen as an unwanted intrusion. If the in-game branded items offer an advantage, then players may come to desire that brand in-game, which may result in increased sales of the actual product. Thus, advertisement content that can be used to trigger in-game changes that confer an advantage may be displayed any time a particular set of in-game conditions are met.

The management application module 160 is a processing and storage module that store/executes a management application. The management application is typically a computer program, in HTML5, including the most recent version of HTML, since the functionality of HTML is useful to implement the features, JavaScript™, or other suitable language, used to facilitate game content assets being distributed and executed by a user device (112, 114). The management application may control transactions, such as purchases of content, accessories, and/or merchandise that a user, utilizing a user device may wish to purchase. The management application module 160 is operatively coupled to network 102 via bi-directional communication medium 161, which is similar to communication media 107, 113, and 122 described herein.

The game application module 162 is a processing and storage module, such as a server, that store/executes a game application. The game application is typically a computer program, such as a video game, and may include additional content, written in a suitable language, used to facilitate game content assets being distributed by the server module 104 and executed by a user device (112, 114). Similar to the management application, the game application may also control transactions, such as purchases of content, accessories, and/or merchandise that a user, utilizing a user device may wish to purchase. The game application module 162 is operatively coupled to network 102 via bi-directional communication medium 163, which is similar to communication media 107, 113, and 122 described herein.

The advertisement module 168 is a processing and storage module that store/executes advertisement content. The advertisement content is typically advertisements for services and/or products and may include video, graphic, audio and other form of electronic data. The advertisement content stored in advertisement module 168 can be accessed by management application 160 and inserted into game content assets that are provided to a user device 112, 114. The advertisement module has a CPU 180 operatively coupled to a memory module 182 to execute the processing and storage functions of advertisement module 168. The advertisement module 168 is operatively coupled to network 102 via bi-directional communication medium 169, which is similar to communication media 107, 113, and 122 described herein.

The above-described architecture enables game content assets to be provided to a user device. The game content may be in JavaScript™, HTML such as HTML5, or the current version thereof, or other suitable language. An internet video link may be used as an infrastructure to deliver media contents such as video, music, audio files and other electronic data. A framework, which may be an HTML framework, may be delivered in the form of an application bundle (game application and management application). This framework may be used to change an IPTV device (112) into a gaming computing core.

One embodiment of the present invention is directed to using an HDTV device (112), a user downloads the code, such as HTML5, or the most current version thereof, which is typically embodied as a framework bundle that contains a thin application web server and compatible browser, such as an HTML compatible browser. The framework configures itself to accept calls, such as AJAX/IR calls and sends out requests, such as HTTP/HTTPS requests to the game application. The configuration include permissions for the framework to access the IPTV devices' CPU, software/hardware utilities, network capabilities (ports, requests, etc.), memory, graphic rendering engine, and other components or modules. A second display device (114), such as a smartphone, can identify the computing core through a network discovery protocol and download game content assets, such as an HTML game. The game content asset is provided by a server (104) and rendered by an associated web browser. Thus, to play or interact with the game content asset, the user, or users, can transmit a response, typically using AJAX/IR instructions. These AJAX/IR responses can be used by the management application and/or other components and/or processing modules, as described herein.

For some game content assets, typically less sophisticated game content assets, existing remote control devices can be used as a client (112, 114). Using the remote controller (114) a game content asset is downloaded onto the web browser of the associated computing core. The game content asset accepts IR commands from the client, or user device, (112) that are translated into a language, such as XML, that are understood by the game in the form of events/triggers/actions. The game content asset can be mapped to the remote control device (114) buttons and thus, a user pressing the remote control buttons transmits game commands to the computing core to interact with the game content asset.

Furthermore, in a single or multi-player game, the associated computing core manages the various players and calculates states, sessions and scores. This game data may be transmitted and stored at a remote memory location, such as server (104) or other module that can store the game data. Therefore, the “intelligence” of the system 100 resides in the downloaded application gaming bundle (framework), also referred to herein as the management application. The client modules (112, 114) may be “dumb” terminals. Another embodiment of the present invention includes a network game in which a plurality of players using different devices, simultaneously play the same game. The computing core manages communication between the players and the web-app(s) to support network play.

FIG. 2 shows an example of a user device 112 that may be used according to an embodiment of the present invention. User device 112 typically includes a display unit 202, a central processing unit (CPU) 204 and memory 206. The user device 112 also has a user interface (UI) 210, speaker 212, auxiliary display unit 214, peripherals 216 and I/O port 218. The user device 112 also has a bi-directional communication channel 113, as described above. Also shown are secondary devices 114(a), 114(b) . . . 114(n) (where “n” is any suitable number). These secondary devices 114 may be IPTV devices, cellphone, remote controller or other device that is used in conjunction with user device 112.

The display unit 202 is typically an LCD display, plasma, high definition television screen, laser phosphor display, or other device suitable display unit to display electronic data, for example, in the form of pixels.

CPU 204 is an example of at least one processor, such as an Intel Core™ 2 microprocessor or a Freescale™ PowerPC™ microprocessor, used to process the data in memory 206.

Memory unit 206 is an electronic storage medium suitable to store electronic data, including streaming files, flat files, audio and/or video data or any combination thereof. Memory 206 may also include data storage devices, or units for storing management application 220 and game application 230 and associated algorithms as described herein. The electronic storage modules may include a magnetic disk or an optical disk, and drive (not shown), such as a CD-ROM, DVD-ROM, capable of reading/writing data onto a removable medium, Read Only Memory (ROM) and Random-Access Memory (RAM).

The user device 112 further includes an input and output interface unit, or user interface (UI) 210, which may include a receiver to receive spoken commands and spoken utterances that may be used to obtain content assets, as described herein. Coupled to the input and output interface unit 210 may be other peripheral devices such as, e.g., a keyboard or mouse, an output device, or unit (not shown). Also shown coupled to user device 112 are speaker 212 and auxiliary display 214 such as, e.g., a CRT or LCD display. The user device 112 may be equipped with a browser program suitable for communication with the World Wide Web. Also, peripherals 216 are shown. These may include, for example, gaming accessories, such as a joystick, game console, game controller or other device that enable a user to interact with a game content asset accessed by user device 112.

One skilled in the art will recognize that, although components are depicted as different units, the components can be parts of the same unit or units, and that the functions of one can be shared in whole or in part by the other, e.g., as RAM disks, virtual memory, etc. It will also be appreciated that any particular computer may have multiple components of a given type, e.g., processors, input devices, etc.

The memory 206 may store an operating system such as Microsoft Windows Linux, Mac OS™, Unix™, iOS™ or ANDROID™.

The user device 112 may also include additional components and/or systems, such as network connections, additional memory, additional processors, network interfaces, input/output ports or busses or receivers to receive spoken utterances. Also the programs and data may be received by and stored in the system in alternative ways. For example, a computer-readable storage medium (CRSM) reader, such as, e.g., a magnetic disk drive, magneto-optical drive, optical disk drive, or flash drive, may be read from a computer-readable storage medium (CRSM) such as, e.g., a magnetic disk, a magneto-optical disk, an optical disk, or flash RAM. Further, it will be appreciated that the term “memory” herein is intended to include various types of suitable data storage media, whether permanent or temporary, such as transitory electronic memories, non-transitory computer-readable medium and/or computer-writable medium.

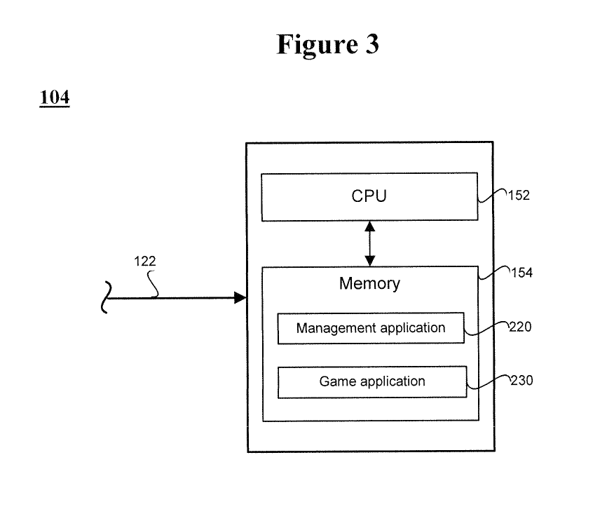

FIG. 3 shows an example of a server module 104 that may be used according to an embodiment of the present invention. Server module 104 typically includes a central processing unit (CPU) 156 and memory 154. Bi-directional communication channel 122 is also shown.

CPU 156 is an example of at least one processor, such as an Intel Core™ 2 microprocessor or a Freescale™ PowerPC™ microprocessor, used to process the data in memory 154, or other data retrieved or accessed via network 102 (shown in FIG. 1).

Memory unit 154 is an electronic storage medium suitable to store electronic data, including streaming files, flat files, audio and/or video data or any combination thereof. Memory 154 may also include data storage devices, or units for storing management application 220 and game application 230 and associated algorithms as described herein. The electronic storage modules may include a magnetic disk or an optical disk, and drive (not shown), such as a CD-ROM, DVD-ROM, capable of reading/writing data onto a removable medium, Read Only Memory (ROM) and Random-Access Memory (RAM).

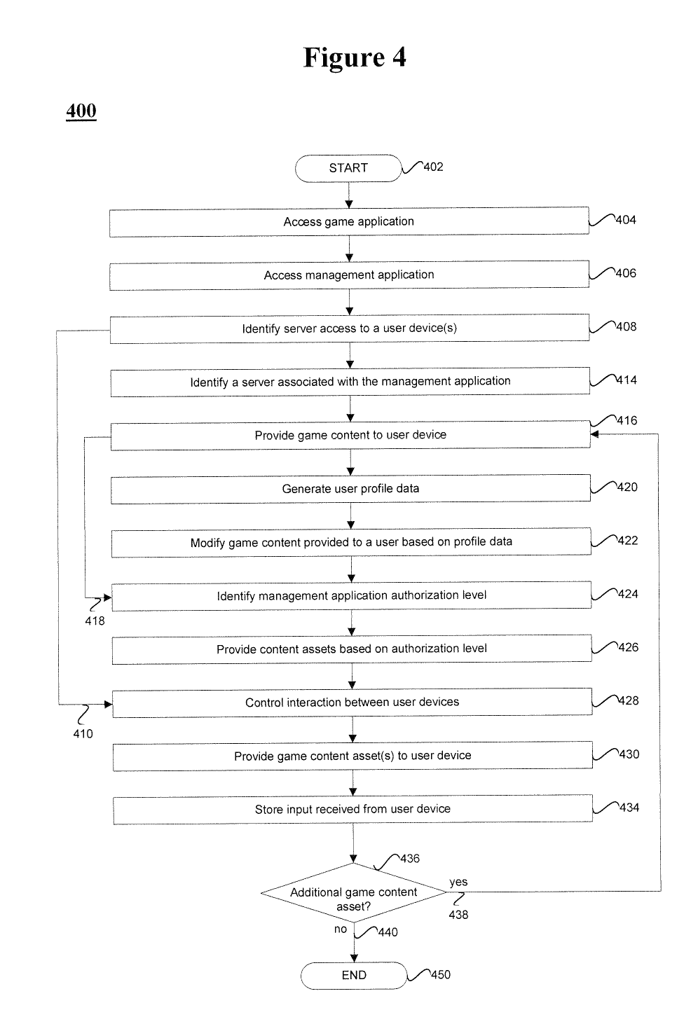

FIG. 4 shows a series of steps 400 that can be used to provide game content to a user according to another embodiment of the present invention. The steps 400 may be stored on a suitable electronic storage medium, such as a computer-readable medium, which may be non-transitory, or RAM. The steps 400 may be object code, source code, or stored on a dedicated storage medium, either local to the user device (FIG. 2, modules 220, 230) or at a remote location, (FIG. 3, modules 220, 230) and accessed as desired. Thus the steps 400 may be considered a module when stored and/or accessed and/or retrieved, regardless of the type of storage medium.

As shown in FIG. 4, the process 400 begins with start step 402. A game application is accessed, as shown in step 404. The game application may include a game content asset, such as a video game, game accessories, music for a video game and other suitable game content. A management application is accessed, as shown in step 406. The management application is computer code that is written in a suitable language, such as HTML5, HTML4, or other HTML language, JavaScript™, that is used to control execution of the game application. A user using a device, such as smartphone (114) can browse content, such as game content that is to be downloaded on an IPTV device (112). Additionally, the game application, which was accessed in step 404 may be stored locally or may be loaded from the network as the game application is accessed.

Execution of the management application includes identifying a secure access connection to one or more user devices (FIG. 1, user devices 112); as shown in step 408. Thus, the management application can generate a session token from the hardware. Since the HTML, or other mark-up language, typically has limited security, the session token provides enhanced security by denying the HTML access to the session token. The management application can also control interaction between multiple user devices, as shown in step 428, reached via line 410. Furthermore, the management application may use a static device identifier when communicating securely with the server. Since the static device identifier is not changed it is sensitive or confidential information. Sensitive or confidential information should not be disclosed or provided to third party code, which some game applications will be. The management application can receive a temporary session token from the server to identify further communication. Since that session token is temporary, there is less risk of exposing sensitive information to the game application. Indeed, all communication with the server, or multiple servers, can go through the management application, which can then keep the session token secret from the game application as the management application adds it to the server communication.

The server, or multiple servers, can provide a separate unique session token that the management application can provide to the game application so that the game applications on all user devices will have a unique identifier that can be used when communicating with the game server (FIG. 1, element 162), which is different than the management server (FIG. 1, element 160). The game server (162) may also be operated by a party that wrote the game application, while the management server (160) may be a server operated by another party.

Indeed, the interaction between multiple user devices, as shown in step 428, can be accomplished by having the multiple devices communicate through one or more servers, or the interaction can be accomplished by having the multiple devices communicate directly with each other. The use of HTML Web Sockets is one method that can be used to have the multiple user devices communicate with each other.

In an embodiment of the present invention, the game application may indicate that it does not need a token for communication, thus obviating step 408. This embodiment allows games that do not communicate with the network to be played when there is no network connection available if they have already been saved on the device.

Alternatively, the management application can identify one or more server modules that it is associated with, as shown in step 414. The particular server module identified may have a relationship with the management application such that the server recognizes the management application, and, as shown in step 416, provide game content assets to a user device. An authorization level of the management application is identified as shown in step 424, reached via line 418. This authorization level may entitle the management application to access additional content assets, as shown in step 426. For example, a management application with enhanced authorization may be able to access and provide content assets that are not available to other management applications. Such content assets may include unreleased music, trailers for unreleased movies, extra video footage and other similar content that is not otherwise available except for the authorization level of the management application.

As another alternative, user profile data can be generated based on a user's gaming, or use, patterns gathered by a user device (112) and provided to the management application, as shown in step 420. The user profile data may include the user's preferred type of game, game playing history, income, previous purchases, other user devices associated with the user and other data about the user.

The game content that is provided to a user may be modified, by the management application, based on the user profile data, as shown in step 422. For example, the management application can insert a notice related to a new release that the user may be interested in purchasing based on the user's previous purchases/gaming.

As stated previously, the management application provides content assets, such as video games, to a user device based on the authorization level of the management application, (steps 424, 426). Alternatively, the management application can also identify and store a rating level of the game content and/or a user account. Thus, the management application will prohibit providing content that exceeds a rating. For example, if a user account identifies the highest rating for game content to be “PG-13” the management application will not provide any game content asset that exceeds the PG-13 rating. Additionally, the management application will also prohibit providing content, such as trailers, and advertisements, with a rating that exceeds PG-13.

The management application manages interaction between user devices. Typically, a single user may have multiple user devices, such as an IPTV device and secondary devices (cellphone, remote controller etc.) that may not be IPTV devices. The management application is used to control receiving commands from multiple devices and providing the content asset to the appropriate one of the multiple user devices. The management application can make a determination based on the functional capabilities of each device as well as the type of content as well as the geographic location of the user. The game content is provided to the user at one or more user devices, as shown in step 430. The provision of the game content is controlled by the management application.

The user may provide input, using one or more user devices, which can be received, as part of the management application execution, as shown in step 434. The user input can be stored and used for additional processing. For example the user may request accessories for a game, or music from the game, or other feedback.

A determination is made in step 436 whether the user wishes any additional game content asset. If so, game content is provided to a user device (step 416, reached by line 438) based on execution of the management application controlling the selection and providing of game content assets.

If no other content asset is desired, the process ends, as shown by line 440 leading to end step 450.

Another embodiment of the present invention is directed to a gaming framework that permits communication related to communicating with user devices to identify the capabilities of a user device and provide content accordingly. The framework, which may be an HTML, framework, may be delivered in the form of an application bundle (game application and management application). This framework may be used to change an IPTV device (112) into a gaming computing core. A user can download the framework (220, 230) to an IPTV device (112). The bundle includes the thin application web server and compatible browser. The framework configures itself as a computing core and the configuration includes authorizations for the framework to access the CPU, software/hardware, network capabilities (ports, requests, etc.), memory, graphic rendering engine, etc. of the IPTV device (112). The IPTV device (112) can also accept calls, such as AJAX/IR calls, sending requests, such as HTTP/HTTPS requests to other modules, including ad server 168. The IPTV device (112) can also manage chats/interactions between players, and publishing content/games to a player's associated social networking site such as FACEBOOK™, MYSPACE™, TWITTER™, LINKIN™ etc.

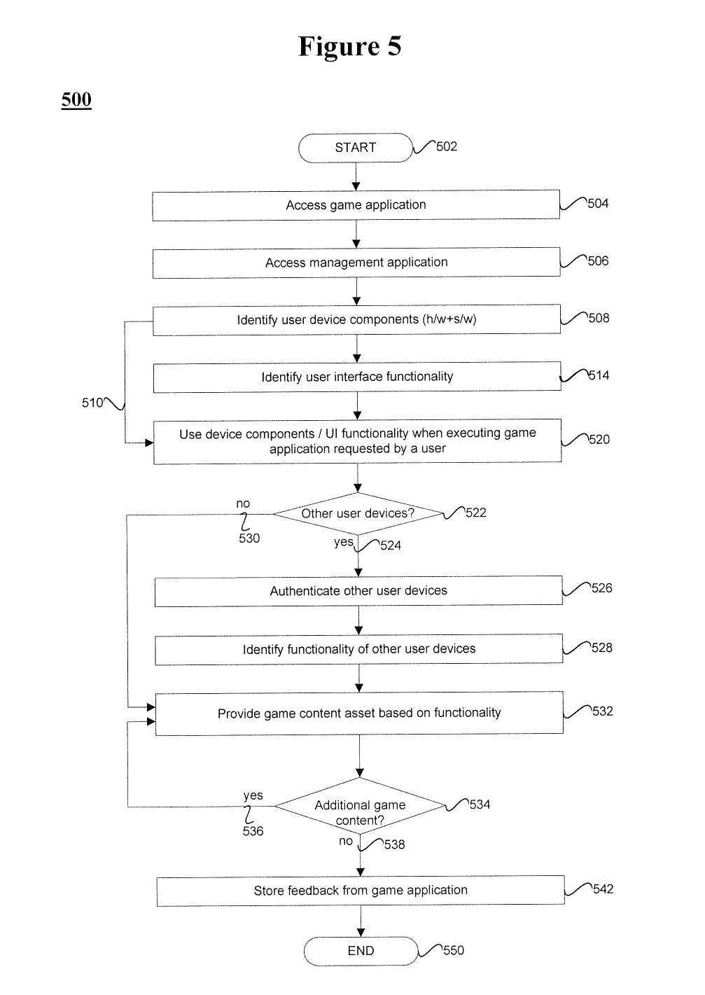

FIG. 5 illustrates a series of steps 500 that can be used to provide device capability information according to yet another embodiment of the present invention. The steps 500 may be stored on a suitable electronic storage medium, such as a computer-readable medium, which may be non-transitory, or RAM. The steps 500 may be object code, source code, or stored on a dedicated storage medium, either local to the user device (FIG. 2, modules 220, 230) or at a remote location, (FIG. 3, modules 220, 230) and accessed as desired. Thus the steps 500 may be considered a module when stored and/or accessed and/or retrieved, regardless of the type of storage medium.

As shown in FIG. 5, the process 500 begins with start step 502. A game application is accessed, as shown in step 504. The game application may include a game content asset, such as a video game, game accessories, music for a video game and other suitable game content. A management application is accessed, as shown in step 506. The management application is computer code that is written in a suitable language, such as HTML5, HTML4, or other language, JavaScript™, that is used to control execution of the game application.

Execution of the management application includes identifying user device components, as shown in step 508. These user device components may include hardware components, such as a joystick, speakers, type of display as well as software components, such as applications available and software stored on the user device.

The UI functionality may be identified as shown in step 514. This includes identifying capabilities of the UI and is used during execution of the management application when providing game content requested by a user.

The execution of the management application can use the user device components (hardware and/or software) (508) as well as user interface (UI) functionality (514) during execution of the game application. Thus, the game application execution will be modified, by the management application, based on the device components and/or UI functionality, as shown in step 520, which may also be reached without identifying the UI functionality, as shown by line 510.

A determination is made whether the user has other user devices associated with their account, as shown in step 522. If the user has additional user devices, the other user devices are authenticated, by the management application, as shown in step 526, reached via line 524. The functionality of the other user devices is identified, as shown in step 528.

The execution of the management program provides game content assets to one or more user devices associated with a user, as shown in step 532. (Step 532 can be reached via line 530 when the user account has only one user device.)

A determination is made whether the user wishes any additional game content assets, as shown in step 534. If so, game content is provided to a user device (step 532, reached by line 536) based on execution of the management application controlling the selection and providing of game content assets.

If no other content asset is desired, the user may provide input, or feedback, using one or more user devices, which can be received, as part of the management application execution. The user feedback can be stored and used for additional processing, as shown in step 542, reached via line 538. For example the user may request accessories for a game, or music from the game, or other feedback. The process ends, as shown by end step 550.

Another embodiment of the present invention is directed to inserting advertisement content into game content assets at an appropriate place in the game content asset. Advertising content can be stored in advertising server (168) to be accessed by the framework and provided to a user device (112, 114).

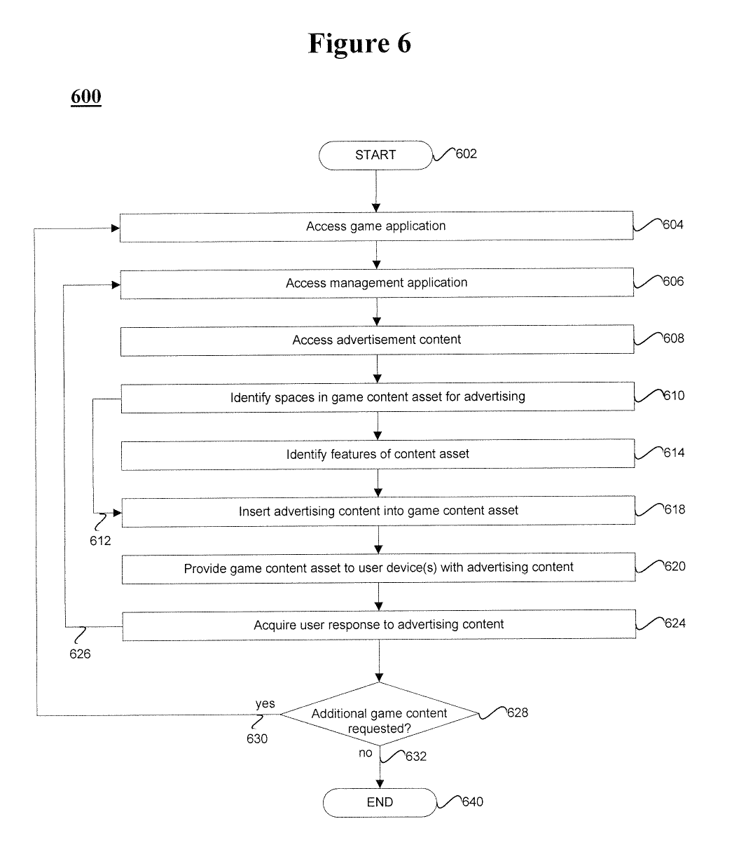

FIG. 6 illustrates a series of steps 600 that can be used to provide advertising content according to yet another embodiment of the present invention. The steps 600 may be stored on a suitable electronic storage medium, such as a computer-readable medium, which may be non-transitory, or RAM. The steps 600 may be object code, source code, or stored on a dedicated storage medium, either local to the user device (FIG. 2, modules 220, 230) or at a remote location, (FIG. 3, modules 220, 230) and accessed as desired. Thus the steps 600 may be considered a module when stored and/or accessed and/or retrieved, regardless of the type of storage medium.

As shown in FIG. 6, the process 600 begins with start step 602. A game application is accessed, as shown in step 604. The game application may include a game content asset, such as a video game, game accessories, music for a video game and other suitable game content. A management application is accessed, as shown in step 606. The management application is computer code that is written in a suitable language, such as HTML5, HTML4, or other suitable mark-up language, or JavaScript™, that is used to control execution of the game application.

Execution of the management application includes accessing advertisement content, as shown in step 608. The advertisement content may be embedded directly inside the game or as an accompaniment to the game content. The advertisements can have specific keywords, context, locations, social-economic status, user profiles, etc. to reflect a target audience for the advertisement. The advertisement content may include commercials, sale notices, promotions or other information related to goods or services that are available to consumers. The advertisement content may be static, which is unchanged throughout the duration of the game session, or dynamic, which can change throughout the duration of a game session. For example, in a dynamic ad, the content of the ad is controlled by advertisement server (168) and may be inserted into the game content as a “pop-up”, slide-in, overlay, window as well as inserted directly into the scenes of the game content asset. For example, placeholder images on a table can be turned into ads inside a game. In one game session, a character may be sitting next to a Coca-Cola™ bottle, or drinking from a Coca-Cola™ bottle. In the next game session, the Coca-Cola™ bottle may be replaced with another soda, such as a Pepsi™ bottle.

Furthermore, clothes, cars, surroundings, venues and other electronic game accessories may be modified to insert ad content into a gaming session. Furthermore, the advertisement content may be in a form of a text string that is integrated into a game's tutorial or dialogue. This is an un-intrusive approach. When a scene with advertisement content is displayed, a slide-in ad can appear and a user can act on the ad by “clicking” or other actuating a response to the ad. Thus, the ad is of minimal distraction to the user. Alternatively, a user can activate additional advertising data related to the advertisement content by “clicking” on the advertisement content. This activation can provide the user with additional information, such as text, promotions or changing aspects or features of the game content asset. The interaction with the advertisement content can change the game content asset. For example, activating the additional advertising data can change clothing, or vehicles or other game components during the display of the game content asset. The particular features can provide an advantage to a user, such as providing a faster car, more valuable weapons and other improved game features for a user. Thus, a user can have access to advertisement content throughout the game. Indeed, the advertisement content may become an event a user looks forward to, since it may provide him/her with an advantage in the game.

The game application can identify spaces or locations that are available to insert advertisement content, as shown in step 610. This may include identification of a time slot between scenes, data locations available to store advertising content, start times for advertisement data and end times for advertisement data. This availability information is used during execution of the management application to correlate suitable advertising content for insertion into the game content asset at an appropriate space in the game content asset, according to the game application.

Furthermore, the identification of features of the game content asset may be used to determine appropriate advertisement content, as shown in step 614. For example, during execution of the management application, scenes or portions of the game content asset may be identified to select advertising content that is of interest to the viewer. For example, after a lunch scene, an advertisement for a pizza restaurant may be inserted, or a coupon for a local pizza restaurant. Based on a match of the content asset scene and the advertising, the management application can insert the most appropriate advertising content, as shown in step 618. Alternatively, the advertising content may not reflect the features of the content, as shown by step 618 being reached via line 612.

Thus, the game content with advertising content is provided to one or more user devices, as shown in step 620. A user may provide a response to the advertising content as shown in step 624. This response is used by the management application, as shown by line 626 reaching step 606. For example, the user response may be user feedback acquired through a user survey after viewing the advertisement, or user purchase data following the advertisement being viewed, or other feedback received from a user related to the content and/or advertising.

If additional game content is requested by the game application, as shown in step 628 a game application is accessed, as shown by line 630 leading to step 604. If no additional content is requested, as shown in step 628, the process ends, as shown in step 640.

The advertisement management and distribution may be controlled by the computing core, or management application. The management may include managing user profiles (location, an indication of economic status, books, music and other data reflecting personal tastes, games played, friends, interests, digital content, buying history, number of connected IPTV devices and other statistics). This information may be used to specifically target users for a particular type of product or service advertisement. Feedback from the user, such as purchases made or intent to buy may also be tracked, stored and used to further target products and users. Users may also vote on an advertisement reflecting how well the user liked the advertisement. The voting results can be stored and processed at the advertisement server (168).

A user device, such as an IPTV device or other processing device may be used as a computing core processor for game content assets. The IPTV device may be used to process gaming scores, interactions and tracking. The IPTV device acts as a proxy to the game application and can store data, make requests and ensure communication is secure. In this embodiment, a user device that has an HTML compatible web browser and thin web server may be used as a computing core. Once a suitable computing core of a user device, or processing module is discovered by an IPTV device (one containing the compatible web browser and thin web server), via a network discovery protocol UDP (User Datagram Protocol) and connected using for example, UPnP (universal plug-n-play), it can be used to manage user profiles, track games played, player's friends lists, interests, digital content owned, buying history, number of connected IPTV devices and other information.

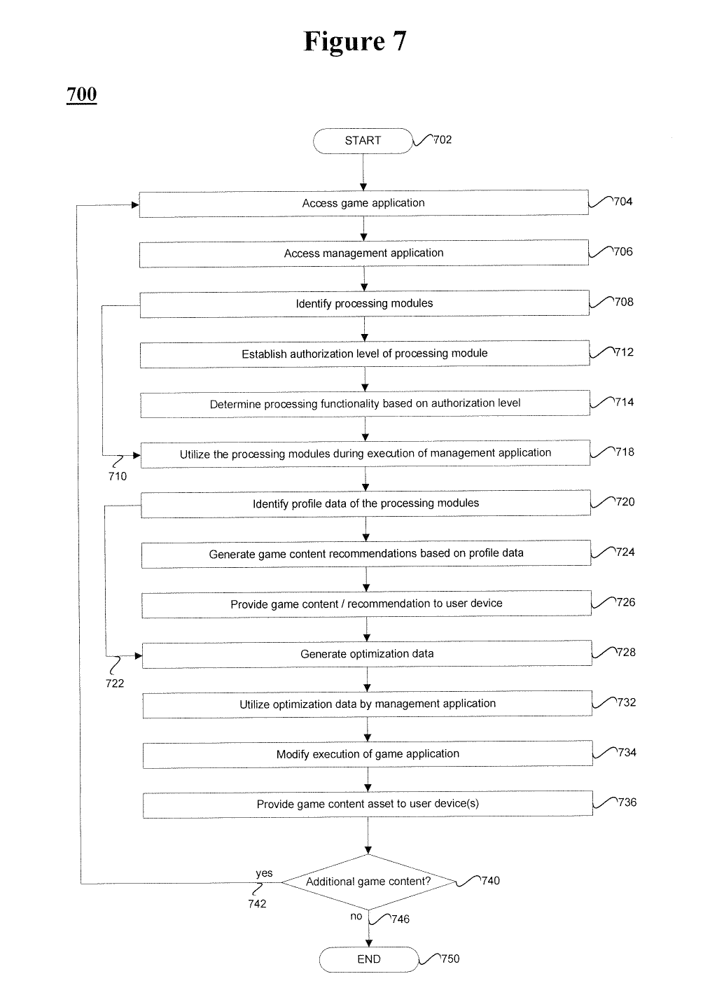

FIG. 7 illustrates a series of steps 700 that can be used to identify additional processing devices according to yet another embodiment of the present invention. The steps 700 may be stored on a suitable electronic storage medium, such as a computer-readable medium, which may be non-transitory, or RAM. The steps 700 may be object code, source code, or stored on a dedicated storage medium, either local to the user device (FIG. 2, modules 220, 230) or at a remote location, (FIG. 3, modules 220, 230) and accessed as desired. Thus the steps 700 may be considered a module when stored and/or accessed and/or retrieved, regardless of the type of storage medium.

As shown in FIG. 7, the process 700 begins with start step 702. A game application is accessed, as shown in step 704. The game application may include a game content asset, such as a video game, game accessories, music for a video game and other suitable game content. A management application is accessed, as shown in step 706. The management application is computer code that is written in a suitable language, such as HTML5, HTML4, or other suitable mark-up language, or JavaScript™, that is used to control execution of the game application.

Execution of the management application includes identifying one or more processing modules, as shown in step 708. The processing modules may be any devices that have a CPU and may include a BLU-RAY™ player, laptop, IPTV device, PSP™, PS3™, or other suitable device. An authorization level of each processing module is established, as shown in step 712. The authorization level determines the processing functionality of each processing module, as shown in step 714. The processing functionality includes what interaction is possible between user devices (112, 114), the level of content the processing module can access, the level of processing the module is capable, the speed of the processing module, and other capabilities of the module.

Furthermore, the processing functionality of the processing modules is utilized, during the execution of the management application, as shown in step 718. The processing functionality may be used during the execution of the management application to facilitate processing controlled by the management application. Thus, if processing tasks can be performed by another processing module, the management application provides instructions to distribute the processing tasks to those modules. This step can also be reached from step 708, via line 710.

Profile data of the processing module(s) is identified, as shown in step 720. The profile data includes status information for the processing module, such as available memory, interconnection information, purchasing information, content accessed from the module, and other information about the users who accessed the module.

Game content recommendations can be generated by the management application based on the profile data, as shown by step 724. These recommendations are provided to a user device, as shown in step 726. Thus, a user who frequently purchases content and accessories may be presented with new game releases that are available for purchase. Also, a user's income will be used to determine what products are offered to that user. When less is known about a particular user, such as for the user of a new device that does not have any history, more generic recommendations can be given based on marketing decisions as to what content to promote.

The management application can also be used to generate optimization data, as shown in step 728. This step (728) may also be reached from the identification step (720) via line 722. The optimization data is based on the processing capabilities and processing tasks that are to be performed. The management application determines what processing modules are available and matches the available processors to processing tasks. The optimization data is utilized by the management application to facilitate efficient processing, as shown in step 732. Indeed, the management application may modify execution of the game application based on the optimization data, as shown in step 734. The execution of the management application with the game application and the optimization data is implemented to provide game content assets to a user device and also maximize processing capabilities of the identified processing modules, as shown in step 736. The effects of the optimization data may include, for example, a dynamic graphical component that is rendered with a lower resolution on a slower (less processing capacity) device in order to maximize the speed of the game, while that same dynamic graphical component may be rendered with a higher resolution on a faster device to maximize the quality of the graphics.

Additionally, the graphical rendering speed portion of the optimization data can be measured by the game application or management application by timing how long it takes to perform one or more sets of graphical manipulations. Thus, no communication from the user device, or other knowledge of the device hardware is needed to determine the graphical speed of the device hardware.

If additional game content is requested by a user, as shown in step 740, a game application is accessed, as shown by line 742 leading to step 704. If no additional content is requested, as shown in step 740, the process ends, as shown in step 750, via line 746.

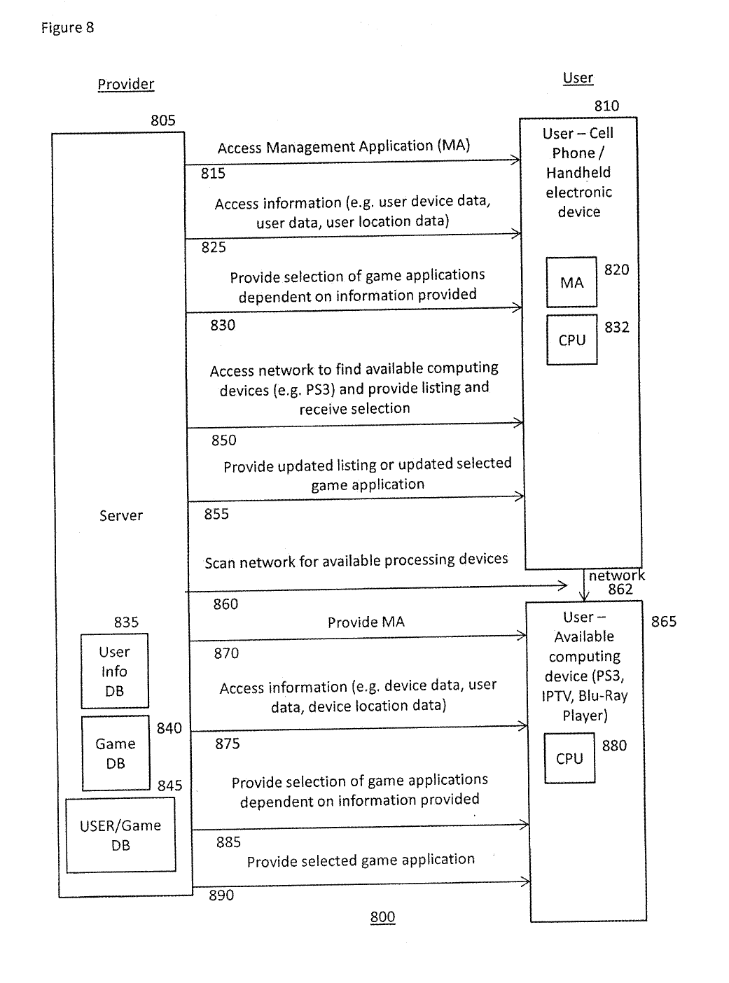

FIG. 8 illustrates a flow of instructions and content between various modules according to yet another embodiment of the present invention.

FIG. 8 shows a representation 800 of the general capabilities of a content provider in one embodiment of the present invention. A server 805 operating as a provider has network connective capability to one or more user devices, shown generally as device 810, such as a IPTV, Blu-Ray™ player, or a PlayStation 3™ cell phone or other handheld device, a tablet computer, a netbook, laptop, ultrabook, etc. The server 805 may access a management application 820 loaded on the user device 810 as shown in action 815. If the management application is not loaded onto the user device 810, the server may send the management application, or file providing an installation application, or a link providing access to download the management application or installation file, or any other means of accessing an installation file for installing the management application.

The server 805 may then access information on the user device 810 acquired by the management application 820 as shown in action 825. The information may include user device data such as data related to the CPU 832, such as speed, make, and/or model, data related to the operating system, data related to the video and/or audio related hardware or software, data related to the hard drive, data related to contents of the hard drives, data related to the number and type of available input devices and related software, data related to connected devices and related software. The information may also include user data, such as usage data related to any of the user device data. The information may also include user location data, such as GPS coordinates in a satellite accessible device, or nearest cell tower in a 3G, 4G, or other cellular accessible device. The user location data may be network related, such as the device being on the home network, a work network, a open network, an encrypted network, or a public network (e.g. Starbucks™), which can be traced to a specific address. The information may also include permission data or settings related to specific accessible information or specific inaccessible information.

In action 830, the provider may use any combination of the information accessed in action 825 to provide a selection of game applications or any other media content. For example, a list of game applications may be provided that can be run on a user device with hardware and software capabilities of the user device 810. The game applications may be modified in such a way that background music is related to the user device media contents accessed in action 825. The game applications may also provide prizes related to nearby shops, based on the user location data. The server 805 may also access a selection made by the user and provide the user device 810 with the content related to the selection. The server 805 may also provide the user device 810 with any related content, such as coupons, music, movie previews, advertisements.

The server 805 may store any information accessed in action 825 into a user information database 835. The availability of storable information may be dependent on permission data or settings acquired in the use device data. The server 805 may also store information related to user's play in a specific game application in a user/game database 845. The server 805 may provide the game applications from a game database 840.

The server 805 may access the user device or the network 862 to find available computing devices as shown in action 850. The server 805 may also provide a listing to the user of the available computing devices allowing for a selection by the user. The server 805 may also select one or more of the available computing devices based on criteria of its own, such as most computing power available. In action 855, the server 805 may provide an updated listing of available game applications of media content. Alternatively, the server 805 may provide an upgraded version of the selected game application. For example, if a user device 810 is running a low definition version of a game application, the server 810 may provide an enhanced version. The upgraded version may alternatively involve better graphics, higher quality music, faster 3D rendering, and/or faster game play.

In action 860, the server 805 may scan the network 862 itself for available computing devices. Scanning the network instead of accessing the user device 810 network application may free up processing power of the user device 810.

The server 805 may provide an available computing device 865 with a management application, in action 870. The available computing device 865 may include an IPTV, Blu-Ray™ player, or a PlayStation 3™, cell phone or other handheld device, a tablet computer, a netbook, laptop, ultrabook, etc. The management application provided to the computing device 865 may be the same or a different version than that of the user device 805. For example, the management application loaded onto user device 810, which may be a cellular phone, may comprise more features than that of a management application loaded onto a connected Blu-Ray™ player because all the selection data is provided to and accessed from the user device 805 and such features are not necessary on any available computing device.

In action 875, the server 805 access information on the available computing device 865, such as information related to the CPU 865. Alternatively, the CPU related data may be collected and/or stored action 850 or 860. Action 875 may access all the same type of information as accessed in action 825. In action 885, the server 805 provides a listing of game applications or content available. This provided listing may differ from previous provided listings in that this listing may be provided to a display of the available computing device 865. The listing in step 885 may also comprise higher quality versions of previously available game applications or contents or may comprise entirely different game applications or content, provided as a function of the information accessed in action 875.

Additionally, as shown in FIG. 8, a previously accessed game may be stored on a user device (810 and/or 865) so that the game does not need to be loaded to the user device to be accessed again. A game that is stored locally will start significantly faster as little or no data needs to be transferred before game play can begin. Also, if the game is stored locally on the user device and the game does not need network access for the game play, the user can play the game even when the device is not connected to a network. When presenting game choices to users, the game options that are stored locally can be indicated on the list to the user and may be sorted to appear at the beginning of the list or a separate area. While most games that are stored locally will probably not require any additional payment to play, some games may communicate with a server when started to ensure that proper payment for play, such as having a current account, have been made.

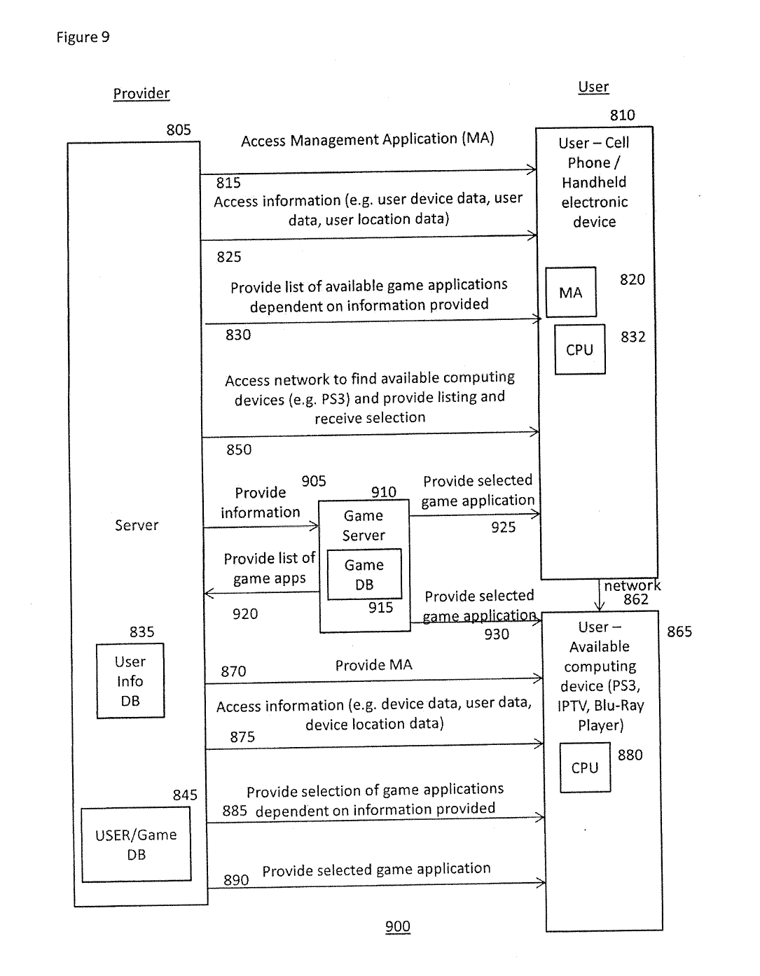

FIG. 9 illustrates a flow of instructions and content between various modules according to yet another embodiment of the present invention.

FIG. 9 shows a representation 900 of the general capabilities of a provider and separate game server in one embodiment of the present invention. Because the server 805 was discussed in FIG. 8, like elements are given the same reference signs and duplicate discussion will be omitted.

In action 905, the server 805 may provide a game server 910 comprising a game database 915, with the information accessed in action 850 and/or action 875. The game server may comprise any media content, such as video or audio media or advertisement data. As shown in action 920, the game server 910 may provide the server 805 with a listing of game applications in response to the provided information. Alternatively, the game database may provide the listing of game application directly to the user device 810 and/or available computing device 865. The game sever may access the selection of the game application or media content. In action 925, the game server 910 provides the selected game application or media content to the user device 810. In action 930, the game server 910 provides the selected game application or media content to the available computing device 865.

For security purposes or based on permission settings, the game server 910 may be unable to access the user device 810 or available computing device 865 directly. In that case, alternatively, the server 805 may access the selection and provide the selection data to the game server 910. The game server 910 may then provide the selected game application or media content to the server 805, which then may provide the game application or media content to the user device 905 and/or available computing device 865.

It is also an embodiment of the present invention that an infrastructure that facilitates management of games through an internet content system, such as an Internet Video Link (IVL) for example the BRAVIA INTERNET VIDEO LINK™ (BIVL) system may also be used.

An internet content system may operate separately, or in conjunction with the management application described herein. For example, utilization of an Internet content system having the same format can be used to deliver game choices to a device that is used to deliver content choices to a device. For example, on the BIVL™ there may be an on-line entertainment service, such as Sony Online™ (games) in the same set of services that contains Netflix™ (video) and Pandora™ (audio).

The user may also browse through game choices using the same UI (user interface) that they use to browse through internet media (video, audio) choices. Any navigation features, such as searching will also work across media content and game content.

The same mechanisms may also be used to affiliate devices with game users and game content services that is used to affiliate devices with media consumer users and media content services. There is no need for separate steps to affiliate a device to a user for game play and for content services. For example, the BIVL™ system provides the Essentials web site for device affiliation.

Additionally, the same management system may be used for providing services of games as for providing services of content. The infrastructure described herein may be used to control what content is available to each device.

Furthermore, users can control which services appear on their device. For example, a service providing content (games, video, audio and other types of content) that is not appropriate for all ages may not appear on a device as a choice until the user enables that service through a service management system (web site, on device, or other mechanism).

In another embodiment of the present invention, a service, such as a subscriber service, may contain both game and media assets. This combination provides an enhanced user experience of the service. For example, the service may provide media content related to the game content. Video content related to the game choices may include trailers for the game content, examples of game play, or commentary about the games. Audio content related to the game can include songs from the game soundtrack or commentary about the game. While the media content does not necessarily have to be related to the game, the media content is typically of more interest to the user if the media content does relate to the game.

As described above, security for the delivery of game content may also use a session token to prevent piracy and cheating. A security model may include, for example, having the user device only trust code from certain sources, using a device identifier that is only exposed to trusted code, limiting what entrusted code can access on a device, and using only secure network communications when transferring game content or media content to a device. Other security measures can be implemented as appropriate for the device and service design.

Similarly, the same mechanisms for purchase and/or rental of media content may also be used to provide for purchase and/or rental of game content. Thus, the existing internet content structure may be used as an app store. For example, the user may have a PayPal™ account or credit card associated with their device or user account. Alternatively, the user may have their device or user account associated with a PLAYSTATION™ Network account, which has a wallet with a balance of funds that may be used for purchases on the system. Purchases on the network may need to go through a standard user interface (UI) that may require a PIN number or other authentication method.

User data from both media activity and game activity may be associated with the same device, which can be combined to provide advertisements that are more accurately targeted, both during game play and during media consumption.

Additionally, one or more second display devices (FIG. 1, element 114) may be used as game controllers. For example, two second display devices may be used as controllers for the same game, thereby allowing two players to interact with their user devices (i.e., smart phones) to control a game that was being run and displayed on another display device, such as their television. Both players have an equivalent quality controller for the game, which offers an enhanced gaming and viewing experience. The second display devices may also display a web page that provides a UI for the game controller that was written by the game developers. When the user interacts with the controller UI on their second display device, that interaction is communicated to the game device (i.e., IPTV device). This may be either a direct communication or via a server if the game device (IPTV device) is not addressable by the second display devices.

Other embodiments of the present invention will now be described in relation to the figures.

One embodiment of the present invention is directed to a method for providing data to a user device. The method includes accessing at least one game application for providing one or more associated game content assets to the user device and accessing at least one management application. The management application communicates with the game application to control execution of the game application. Advertisement content is accessed. Game content assets and selected advertisement content are provided to the selected user device based on the executed management application.

Another embodiment of the present invention is directed to the method for providing data described above, wherein the game application identifies available locations in the game content asset to insert advertising content. Thus, where the game content asset permits, advertisement data is inserted. This makes the advertisement data less intrusive to the gaming experience and permits efficient advertising time, since the advertisement data is inserted in places of the game that are suited for the length and/or content of the advertisement content.

Yet another embodiment of the present invention is directed to the method for providing data described above, wherein the management application provides advertisement content based on the available locations in the game content.

Yet another embodiment of the present invention is directed to the method for providing data described above, wherein the selected advertisement content is static.

Yet another embodiment of the present invention is directed to the method for providing data described above, wherein the selected advertisement content is dynamic.

Yet another embodiment of the present invention is directed to the method for providing data described above, wherein the management application identifies advertising space in the game content assets. For example, each game may have a particular amount of time/space available for advertisements. The management application can use that information to associate appropriate advertisement content for each game content asset.

Yet another embodiment of the present invention is directed to the method for providing data described above, wherein the management application sends a request to a source of advertising data for a particular type of advertisement content. Thus, the advertisement data can be specific to a particular user or particular game. This makes the advertisement more accurately targeted to the user.

Yet another embodiment of the present invention is directed to the method for providing data described above, wherein the management application provides user profile information with the request. Thus, the user profile data may be used to determine advertisement content that the user will view. By using the user profile data to select advertisements, the likelihood that the user will make a purchase based on the advertisement increases.

Yet another embodiment of the present invention is directed to the method for providing data described above, wherein the selected advertisement content includes one or more links to other content. Thus, a user can access additional information by “clicking” or activating a link provided in the advertisement content.

Yet another embodiment of the present invention is directed to the method for providing data described above, wherein the selected advertisement content is based on a portion of the game content asset. Thus, advertisements can relate to what is happening in the game when the advertisement is displayed. For example, during a car chase, an advertisement for a car may be shown.

Yet another embodiment of the present invention is directed to the method for providing data described above, wherein the selected advertisement content is based on a current state of the game content asset. Thus, depending on an action level or intensity level of he game, a similar action level or intensity level advertisement may be displayed. Thus, a user will not be subjected to a change in tempo when an advertisement is displayed.

Yet another embodiment of the present invention is directed to the method for providing data described above, wherein the selected advertisement content includes content related to a second game content asset. Thus, the advertisement may be related to another game that the user may be interested in.

Yet another embodiment of the present invention is directed to the method for providing data described above, wherein the management application collects rating data related to the selected advertisement content. A user may provide feedback regarding their opinion of the advertisement and the management application can collect that user feedback.

Yet another embodiment of the present invention is directed to the method for providing data described above, wherein the management application collects revenue data related to the selected advertisement content. The revenue data can reflect how many purchases and/or how much revenue was generated based on people viewing the advertisement and then making purchases of the advertised products. This is typically done by monitoring when the advertisement content was displayed and correlating the advertisement display with sales data.

Yet another embodiment of the present invention is directed to the method for providing data described above and also includes collecting revenue data related to the selected advertisement content. Thus, the amount of revenue generated by displaying advertisement content can be collected to determine how profitable the advertisement content is.

Yet another embodiment of the present invention is directed to the method for providing data described above, wherein the management application collects viewing data related to the selected advertisement content. The management application can collect information regarding how many times and the duration of the viewing of the advertisement.

Yet another embodiment of the present invention is directed to the method for providing data described above and also includes collecting viewing data related to the selected advertisement content.

Yet another embodiment of the present invention is directed to the method for providing data described above and also includes identifying a second user device, for providing input to the provided game content assets. A first representation of the one or more game content assets and selected advertisement content are provided to the user device. A second representation of the one or more game content assets and selected advertisement content are provided to the second user device.

Yet another embodiment of the present invention is directed to the method for providing data described above, wherein the selected advertisement content provided to the user device and the second user device is based on a user of the respective device. Thus, more than one user may be able to use a particular user device. The selected advertisement is provided based on a specific user of a device.

Yet another embodiment of the present invention is directed to the method for providing data described above, wherein the selected advertisement content is modified based on capabilities of a user device displaying the advertisement content. Thus, advertisement content that requires more sophisticated functionality than a user device has, will not be provided to a user device that is not capable of adequately utilizing the advertisement content.

Yet another embodiment of the present invention is directed to the method for providing data described above, wherein the modified selected advertisement content is independent of the game content asset.

Yet another embodiment of the present invention is directed to the method for providing data described above and also includes modifying the game content asset based on user interaction with the selected advertisement content.

Yet another embodiment of the present invention is directed to the method for providing data described above, wherein the modification of the game content asset includes modification of objects of the game content asset.

Yet another embodiment of the present invention is directed to the method for providing data described above, wherein the modification of the game content asset includes modification of branding of the game content asset. For example, a different make of a car may be used in the game based on the advertisement content for a particular type of car. Also, a brand of apparel a character is wearing may change after an advertisement for a brand of clothing is displayed.

Yet another embodiment of the present invention is directed to the method for providing data described above, wherein the modification of the game content asset includes in-game advantages for the user.

Yet another embodiment of the present invention is directed to the method for providing data described above, wherein the advertisement content allows a user to activate the advertisement content.

Yet another embodiment of the present invention is directed to the method for providing data described above, wherein the activated advertisement content includes providing additional information to the user. Thus, a user can access more details about a product or service that was the subject of an advertisement.

Yet another embodiment of the present invention is directed to the method for providing data described above, wherein the activated advertisement content includes modifying brands of products of the game content asset.

Yet another embodiment of the present invention is directed to a method for providing content to a user device that includes accessing one or more game content assets by the user device; accessing at least one management application, the management application controlling execution of the game content assets; identifying one or more processing modules that are available for use by the management application; providing one or more game content assets to the selected user device based on execution of the management application; and utilizing one or more of the identified processing modules based on execution of the management application to perform processing functionality.

Yet another embodiment of the present invention is directed to the method for providing content described above, wherein the step of identifying one or more processing modules further includes establishing an authorization level of the processing module.

Yet another embodiment of the present invention is directed to the method for providing content described above and also includes determining processing functionality of the processing module based on the authorization level of the processing module.

Yet another embodiment of the present invention is directed to the method for providing content described above and also includes utilizing one or more of the identified processing modules during execution of the management application.

Yet another embodiment of the present invention is directed to the method for providing content described above and also includes utilizing a UDP (User datagram Protocol) in the identifying step.

Yet another embodiment of the present invention is directed to the method for providing content described above and also includes utilizing UPnP (Universal Plug and Play) to connect the identified processing modules to the management application.

Yet another embodiment of the present invention is directed to the method for providing data described above and also includes identifying profile data associated with one or more identified processing modules.

Yet another embodiment of the present invention is directed to the method for providing data described above and also includes generating game content asset recommendations based on the profile data; and providing the recommendations to an associated user.

Yet another embodiment of the present invention is directed to the method for providing data described above and also includes generating optimization data based on the identified processing modules; and utilizing the optimization data during execution of the management application.

Yet another embodiment of the present invention is directed to the method for providing data described above and also includes modifying execution of the game application based on the optimization data.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method for providing content to a user device comprising:
accessing at least one game application for providing one or more associated game content assets to the user device;
accessing at least one management application, the management application communicating with the game application to control execution of the game application;
accessing advertisement content; and
providing one or more game content assets and selected advertisement content to the selected user device based on the executed management application.

2. The method as claimed in claim 1, wherein the game application identifies available locations in the game content asset to insert advertising content.

3. The method as claimed in claim 1, wherein the selected advertisement content is static.

4. The method as claimed in claim 1, wherein the selected advertisement content is dynamic.

5. The method as claimed in claim 1, wherein the management application sends a request to a source of advertising data for a particular type of advertisement content.

6. The method as claimed in claim 5, wherein the management application provides user profile information with the request.

7. The method as claimed in claim 1, wherein the selected advertisement content is based on a current state of the game content asset.

8. The method as claimed in claim 1, further comprising collecting revenue data related to the selected advertisement content.

9. The method as claimed in claim 1, further comprising:
identifying a second user device, for providing input to the provided game content assets;
providing a first representation of the one or more game content assets and selected advertisement content to the user device; and
providing a second representation of the one or more game content assets and selected advertisement content to the second user device.

10. The method as claimed in claim 9, wherein the selected advertisement content provided to the user device and the second user device is based on a user of the respective device.

11. The method as claimed in claim 1, further comprising:
modifying the game content asset based on user interaction with the selected advertisement content.

12. The method as claimed in claim 11, wherein the modification of the game content asset includes modification of objects of the game content asset.

13. The method as claimed in claim 12, wherein the modification of the game content asset includes modification of branding of the game content asset.

14. The method as claimed in claim 12, wherein the modification of the game content asset includes in-game advantages for the user.

15. The method as claimed in claim 1, wherein the advertisement content allows a user to activate the advertisement content.

16. The method as claimed in claim 15, wherein the activated advertisement content includes modifying brands of products of the game content asset.

17. A method for providing content to a user device comprising:
accessing one or more game content assets by the user device;
accessing at least one management application, the management application controlling execution of the game content assets;
identifying one or more processing modules that are available for use by the management application;
providing one or more game content assets to the selected user device based on execution of the management application; and
utilizing one or more of the identified processing modules based on execution of the management application to perform processing functionality.

18. The method as claimed in claim 17, wherein the step of identifying one or more processing modules further comprises:
establishing an authorization level of the processing module.

19. The method as claimed in claim 18, further comprising:
determining processing functionality of the processing module based on the authorization level of the processing module.

20. The method as claimed in claim 17, further comprising:
utilizing one or more of the identified processing modules during execution of the management application.

21. The method as claimed in claim 17, further comprising:
utilizing a UDP (User datagram Protocol) in the identifying step.

22. The method as claimed in claim 17, further comprising:
identifying profile data associated with one or more identified processing modules.

23. The method as claimed in claim 22, further comprising:
generating game content asset recommendations based on the profile data; and
providing the recommendations to an associated user.

24. The method as claimed in claim 17, further comprising:
generating optimization data based on the identified processing modules; and
utilizing the optimization data during execution of the management application.

25. The method as claimed in claim 24, further comprising:
modifying execution of the game application based on the optimization data.
